(19) United States
(12) Patent Application Publication
(10) Pub. No.: US 2014/0129364 A1
(43) Pub. Date: May 8, 2014

(54) CAPTURING VALUE OF A UNIT OF CONTENT

(71) Applicant: YAHOO! INC., Sunnyvale, CA (US)

(72) Inventor: John Corrigan, Los Altos, CA (US)

(73) Assignee: Yahoo! Inc., Sunnyvale, CA (US)

(21) Appl. No.: 13/672,444

(22) Filed: Nov. 8, 2012

(51) Int. Cl. G06Q 20/22; G06Q 30/08

(52) U.S. Cl. CPC G06Q 20/22; G06Q 30/08
USPC 705/26.3; 705/39

(57) ABSTRACT

Various component values of original content items are extracted via an initial publication and republication of content items. An original, unpublished content item is initially made available for discovery and purchase by different content distributors. When a content distributor first purchases the content item for publication, it is no longer available to other content distributors for an initial time period which can be configured based on different component values of the content item. Upon the expiry of the initial time period, the content item is again provided to various content distributors for republication.

The present disclosure relates to maximizing the value of an original unit of content.

### BACKGROUND

The Internet is a source of vast amount of information. A large part of this information is made available from millions of different content providers either for free or at a cost. The content providers may publish their content either directly on their own websites and/or may provide their content to various other content distributors via content syndication platforms such as, Vertical Acuity or News Distribution Network. Website owners or content owners can employ the content syndication platforms to expand the reach of their content by providing their website material to multiple other sites. Content may also be syndicated as RSS or Atom feeds with headlines or summaries generated on content consumers' feed readers. Such syndication not only provides income to the content owners but also increases the visibility of a webpage including their content in a search engine's “natural” or “organic” search results thereby contributing to increasing the SEO (Search Engine Optimization) value of the webpage.

### SUMMARY

This disclosure facilitates a content originator to exploit the various component values of an original content item or an original unit of content in different stages. A method of providing content is disclosed in an embodiment. The method includes various steps executed by one or more processors. The processor provides an item of content or a content item for initial publication to by a first content distributor, determines satisfaction of a transaction condition for the initially published content item provided to the first content distributor and subsequently provides the initially published content item for re-publication to one or more other content distributors different from the first content distributor upon the satisfaction of the transaction condition. The processor is further configured to detect expiry of a predetermined first time period. In an embodiment, the initially published content item is provided for republication to a plurality of content providers at a predetermined price whose final price can be determined in a bidded or non-bidded manner. The predetermined price for the re-distribution of the content item which is already published can be based on one or more of the content types comprised within the content item, a SERP ranking of the initially published content item or on Internet traffic, social sharing, engagement, monetization or cost reduction attracted by the content item when initially published by the first content distributor on a website.

In an embodiment, the transaction condition is satisfied upon the expiry of the predetermined first time period. In an embodiment, determining the satisfaction of the transaction condition by the processor further involves, obtaining, by the processor, a SERP (Search Engine Results Page) ranking of the published content item upon the expiry of the predetermined first time period, monitoring the ranking of the published content item and detecting stagnation of the ranking or decrease in the ranking for a predetermined second time period. In this embodiment, the monitoring of the rank begins after the expiry of the predetermined first time period and the transaction condition is satisfied when the ranking starts to plateau or decrease thereafter for the predetermined second time period.

In an embodiment, determining the satisfaction of the transaction condition by the processor further involves, obtaining, by the processor, a ranking of the content item, monitoring the ranking of the content item and detecting stagnation of the ranking or decrease in the ranking for a predetermined second time period. In this embodiment, the monitoring of the rank begins when the content item is initially published by the first content distributor and the transaction condition is satisfied when the ranking starts to plateau or decrease thereafter.

A computing device comprising a processor and a storage medium for tangibly storing thereon program logic for execution by the processor is disclosed in an embodiment. The program logic can comprise providing logic for providing an content item for initial publication to a first content distributor; determining logic for determining satisfaction of a transaction condition for the content item provided to the first content distributor and republication logic for providing the content item for re-publication to at least one other content distributor different from the first content distributor upon the satisfaction of the transaction condition. In addition, the program logic stored in a storage medium and executed by the processor can also comprise price determining logic for determining a price for the content item based on various factors such as one or more of Internet traffic including social referral traffic and virality. The price may also be determined based on average time spent, average clickthrough rate, average eCPM (effective cost per thousand impressions), cost per lead, cost per acquisition, or editorial/production cost or other traffic-driving, engagement, monetization, or cost reduction indicators. Collecting logic is also stored in a storage medium and executed by the processor for collecting a price for the re-distribution of the content item from the at least one other content distributor via a commercial transaction such as a subscription, revenue share, purchase or content for traffic arrangement. In an embodiment the republication logic executed by the processor further comprises logic, for providing the content item for re-publication to the plurality of other content distributors at the predetermined price. In addition, the program logic can also comprise detecting logic, executed by the processor, for detecting, expiry of a predetermined first time period.

In an embodiment, the determining logic further comprises transaction logic, executed by the processor, for determining that the transaction condition is satisfied upon the expiry of the predetermined first time period.

In an embodiment, the determining logic executed by the processor further comprises obtaining logic for obtaining a SERP (Search Engine Results Page) ranking of the content item upon the expiry of the predetermined first time period, monitoring logic for monitoring the ranking of the content item and identifying logic for identifying stagnation of the ranking or decrease in the ranking for a predetermined second time period.

In an embodiment, the determining logic executed by the processor further comprises obtaining logic, for obtaining a SERP (Search Engine Results Page) ranking of the content item upon the expiry of the predetermined first time period, monitoring logic for monitoring the ranking of the content item and identifying logic, for identifying stagnation of the ranking or decrease in the ranking for a predetermined second time period.

In an embodiment the re-publication logic further comprises auctioning logic, executed by the processor, for auctioning the content item, pricing logic for determining a price for re-distribution of the content item based on results of the auction and selecting logic for selecting at least one other content distributor based on results of the auction.

A computer readable storage medium comprising instructions that can be executed by a processor is disclosed in an embodiment. The instructions when executed by a processor cause the processor to provide an content item for initial publication to a first content distributor, determine satisfaction of a transaction condition for the content item provided to the first content distributor and provide the content item for re-publication to at least one other content distributor different from the first content distributor upon the satisfaction of the transaction condition. The computer readable medium further comprises that cause the processor to detect expiry of a predetermined first time period.

In an embodiment, further instructions are comprised on the computer readable medium that cause the processor to obtain a SERP (Search Engine Results Page) ranking of the content item upon the expiry of the predetermined time period, monitor the ranking of the content item and detect stagnation of the ranking or decrease in the ranking for a predetermined second time period.

In an embodiment, the instructions for determining the satisfaction of the transaction condition further comprise instructions that cause the processor to obtain a ranking of the content item, monitor the ranking of the content item and detect stagnation of the ranking or decrease in the ranking for a predetermined second time period.

In an embodiment, the computer readable medium also comprises instructions that cause the processor to determine a price for the content item based on Internet traffic attracted by the content item when published by the first content distributor on a website. Further instructions are comprised on the computer readable medium in an embodiment which cause the processor to collect a price for the re-distribution of the content item from the at least one other content distributor via a subscription.

These and other embodiments and embodiments will be apparent to those of ordinary skill in the art by reference to the following detailed description and the accompanying drawings.

### BRIEF DESCRIPTION OF THE DRAWINGS

In the drawing figures, which are not to scale, and where like reference numerals indicate like elements throughout the several views:

FIG. 1 is a block diagram depicting certain modules within a publication system in accordance with an embodiment of the present disclosure;

FIG. 2 is a block diagram depicting certain sub-modules within the initial content providing module in accordance with an embodiment of the present disclosure;

FIG. 3 is a block diagram depicting certain sub-modules within the content value monitoring module in accordance with an embodiment of the present disclosure;

FIG. 4 shows a flowchart illustrating an embodiment of a method of extracting traffic-driving SEO value of a content item along with its engagement and cost-reduction value;

FIG. 5 shows a flowchart illustrating embodiments of a methods of detecting satisfaction of a transaction condition;

FIG. 6 shows a flowchart illustrating an embodiment of a method of monitoring rank of a published content item;

FIG. 7 is a schematic diagram showing the internal architecture of a computing device including one or more processing units (also referred to herein as CPUs), which interface with at least one computer bus in accordance with one embodiment of the present disclosure;

FIG. 8 is a schematic diagram illustrating a client device implementation of a computing device in accordance with embodiments of the present disclosure.

### DESCRIPTION OF EMBODIMENTS

Subject matter will now be described more fully hereinafter with reference to the accompanying drawings, which form a part hereof, and which show, by way of illustration, specific example embodiments. Subject matter may, however, be embodied in a variety of different forms and, therefore, covered or claimed subject matter is intended to be construed as not being limited to any example embodiments set forth herein; example embodiments are provided merely to be illustrative. Likewise, a reasonably broad scope for claimed or covered subject matter is intended. Among other things, for example, subject matter may be embodied as methods, devices, components, or systems. Accordingly, embodiments may, for example, take the form of hardware, software, firmware or any combination thereof (other than software per se). The following detailed description is, therefore, not intended to be taken in a limiting sense.

In the accompanying drawings, some features may be exaggerated to show details of particular components (and any size, material and similar details shown in the figures are intended to be illustrative and not restrictive). Therefore, specific structural and functional details disclosed herein are not to be interpreted as limiting, but merely as a representative basis for teaching one skilled in the art to variously employ the disclosed embodiments.

The present invention is described below with reference to block diagrams and operational illustrations of methods and devices to select and present media related to a specific topic. It is understood that each block of the block diagrams or operational illustrations, and combinations of blocks in the block diagrams or operational illustrations, can be implemented by means of analog or digital hardware and computer program instructions. These computer program instructions or logic can be provided to a processor of a general purpose computer, special purpose computer, ASIC, or other programmable data processing apparatus, such that the instructions, which execute via the processor of the computer or other programmable data processing apparatus, implements the functions/acts specified in the block diagrams or operational block or blocks.

In some alternate implementations, the functions/acts noted in the blocks can occur out of the order noted in the operational illustrations. For example, two blocks shown in succession can in fact be executed substantially concurrently or the blocks can sometimes be executed in the reverse order, depending upon the functionality/acts involved. Furthermore, the embodiments of methods presented and described as flowcharts in this disclosure are provided by way of example in order to provide a more complete understanding of the technology. The disclosed methods are not limited to the operations and logical flow presented herein. Alternative embodiments are contemplated in which the order of the various operations is altered and in which sub-operations described as being part of a larger operation are performed independently.

For the purposes of this disclosure the term “server” should be understood to refer to a service point which provides processing, database, and communication facilities. By way of example, and not limitation, the term “server” can refer to a single, physical processor with associated communications and data storage and database facilities, or it can refer to a networked or clustered complex of processors and associated network and storage devices, as well as operating software and one or more database systems and applications software which support the services provided by the server.

For the purposes of this disclosure a “network” should be understood to refer to a network that may couple devices so that communications may be exchanged, such as between a server and a client device or other types of devices, including between wireless devices coupled via a wireless network, for example. A network may also include mass storage, such as network attached storage (NAS), a storage area network (SAN), or other forms of computer or machine readable media, for example. A network may include the Internet, one or more local area networks (LANs), one or more wide area networks (WANs), wire-line type connections, wireless type connections, cellular or any combination thereof. Likewise, sub-networks, which may employ differing architectures or may be compliant or compatible with differing protocols, may interoperate within a larger network. Various types of devices may, for example, be made available to provide an interoperable capability for differing architectures or protocols. As one illustrative example, a router may provide a link between otherwise separate and independent LANs.

A communication link or channel may include, for example, analog telephone lines, such as a twisted wire pair, a coaxial cable, full or fractional digital lines including T1, T2, T3, or T4 type lines, Integrated Services Digital Networks (ISDNs), Digital Subscriber Lines (DSLs), wireless links including satellite links, or other communication links or channels, such as may be known to those skilled in the art. Furthermore, a computing device or other related electronic devices may be remotely coupled to a network, such as via a telephone line or link, for example.

A computing device may be capable of sending or receiving signals, such as via a wired or wireless network, or may be capable of processing or storing signals, such as in memory as physical memory states, and may, therefore, operate as a server. Thus, devices capable of operating as a server may include, as examples, dedicated rack-mounted servers, desktop computers, laptop computers, set top boxes, integrated devices combining various features, such as two or more features of the foregoing devices, or the like. Servers may vary widely in configuration or capabilities, but generally a server may include one or more central processing units and memory. A server may also include one or more mass storage devices, one or more power supplies, one or more wired or wireless network interfaces, one or more input/output interfaces, or one or more operating systems, such as Windows Server, Mac OS X, Unix, Linux, FreeBSD, or the like.

Throughout the specification and claims, terms may have nuanced meanings suggested or implied in context beyond an explicitly stated meaning. Likewise, the phrase “in one embodiment” as used herein does not necessarily refer to the same embodiment and the phrase “in another embodiment” as used herein does not necessarily refer to a different embodiment. It is intended, for example, that claimed subject matter include combinations of example embodiments in whole or in part. In general, terminology may be understood at least in part from usage in context. For example, terms, such as “and”, “or”, or “and/or,” as used herein may include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures or characteristics in a plural sense. Similarly, terms, such as “a,” “an,” or “the,” again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

Search engine optimization (SEO) is valued by web site publishers worldwide because it is a primary source of traffic to their web sites which can then be monetized. The first page of organic search results typically receives ninety five percent of the traffic generated by a user's keyword search. A primary factor for a publisher to achieve the top organic search ranking for a published item of content is being the originator of the content item or the first to publish that content item on the web. Search engines crawl the web for duplicate copies of an article and credit the source publication with the bulk of the value. However, content is priced on a per article or per content item basis without deconstructing the component value of the elements of an article into SEO value versus the other inherent value of the content. Various embodiments described herein provide add-on options for content syndication platforms or content origination platforms to facilitate separating the traffic-driving SEO value of a syndicated content item from its other social sharing, engagement, monetization and cost-reduction value. By implementing such models that separately capitalize on the various component values of a content item, a content publisher can maximize the total value of a piece of content by enabling the SEO value to be maximized and accrued separately from the other value components. In some embodiments, content originators can earn incremental SEO value by initially publishing their own content and can later circulate the content for republication by other third party publishers in order to capitalize on the content's engagement or monetization value.

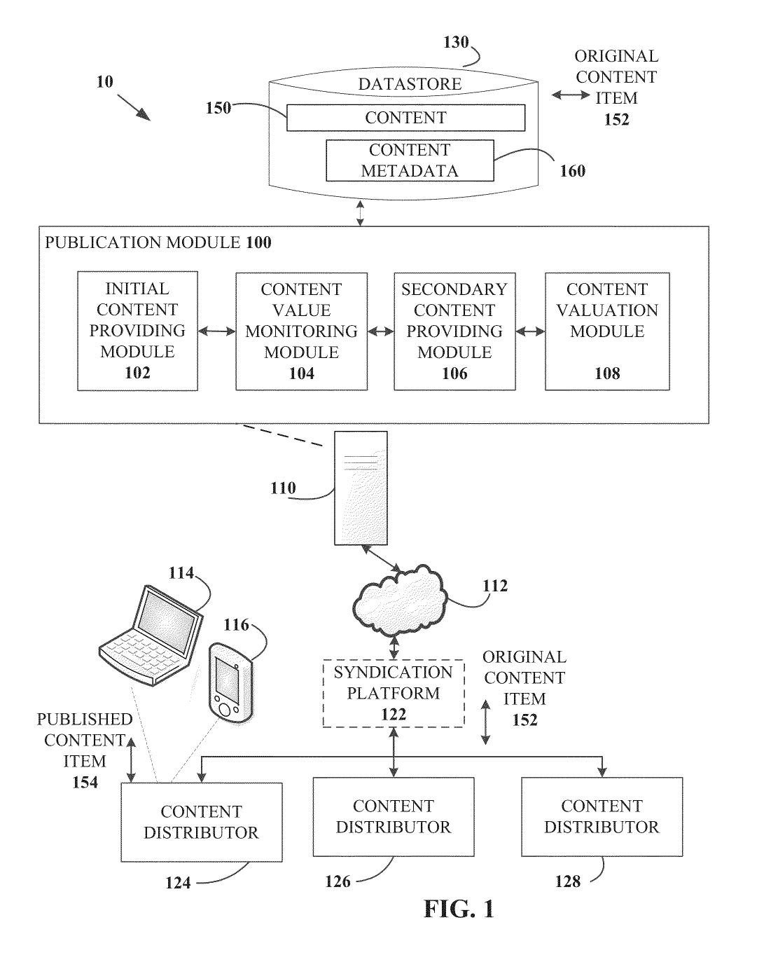

Turning now to the figures, FIG. 1 is a block diagram depicting certain modules within a publication system 10 that facilitates maximizing value extracted from a piece of content published on the Internet. By the way of illustration and not limitation, the piece of content or content item can be a text item such as an article, an audio item or a video item or combinations thereof. The publication system 10 comprises a server 110 that includes a processor (not shown) that executes a publication module 100 and its various sub-modules as detailed herein. The publication system 10 also includes a data store 130 that comprises content 150 and metadata 160 associated therewith which is used for operation of the publication system 10. Although only one data store 130 is shown, it may be appreciated that this is not necessary and that the data of the publication system 10 can be stored in a plurality of networked local or remote data stores. The server 110 is communicatively coupled to the data store 130 in order to facilitate access to the data of the publication system 10 by the publication module 100. In addition, the server 110 is also coupled to the network 112, for example, the Internet, via which it supplies content for publication to one or more third party re-publishers such as content distributors 124, 126 and 128. In an embodiment, the publication system 10 can include an optional intermediary such as a content syndication platform 122 which obtains content from the publication module 100 and further makes the content available for electronic discovery and purchase by one or more of the content distributors 124, 126 and 128. The content thus distributed can be accessed by the users by employing client devices 114, 116. In another embodiment, the publication module 100 can be integrated with the syndication platform 122 so that the various sub-modules of the publication module 100 are part of the syndication platform 122.

In one embodiment, the data store 110 can comprise content 150 which may further include content items that are already published and/or content items that are received from various sources which are yet to be published. In different embodiments, the various sources (not shown) that provide content to the publication module 100 can include other networked databases or content feeds. When a new piece of content item 152 is initially received for publication in the data store 130, it is supplied to the initial publication module 102 of the publication module 100 via a push or a pull process. In one embodiment, the initial content providing module 102 provides it to one of the content distributors, for example, content distributor 124, for publication, for example, on the Internet. In an embodiment, initial content providing module 102 can provide the new piece of content 152 to the content distributor 124 via the syndication platform 122 in a bidded or non-bidded manner at a value provided for example, by the content valuation module 108 which supplies the price at which the new content item 152 may be provided to the content distributor 124. In an embodiment, the publication module 100 can provide the new piece of content 152 for exclusive publication by the content distributor 124 for an initial limited time period. In this embodiment, once the content distributor 124 has purchased the new piece of content 152 for publication, the initial content providing module 102 (or the syndication platform 122) changes the status of the new piece of content 152 to unavailable for purchase, for example, in the content metadata 160 of the data store 130. Such change in its status makes the new content item 152 undiscoverable in the publication system 10 by other distributors 126, 128. The content distributor 124 is thus the first and exclusive publisher of content item 154 corresponding to the new piece of content 152. This may be conveyed, for example, via insertion of a canonical tag in the published content item 154 when placed in the public domain, for example, via the Internet.

Upon publication of the content item 154 by content distributor 124, the content value monitoring module 126 captures the URL (universal resource locator) of the published content 154, monitors time elapsed from the initial publication date and the organic search ranking of the article. Any one of the various commercially available tools can be employed to obtain the organic search ranking associated with a particular URL. The organic search ranking of the published content item 154 can depend on its SEO (search engine optimization) when it is initially published since the content item 154 has to be discoverable by search engines which drive network traffic. SEO is the practice of optimizing a webpage via different methodologies in order to improve its ranking in organic searches thereby attracting more visitors. Therefore, by initially publishing an exclusive piece of content 154 which is optimized for discovery by search engines, content distributor 124 is able to attract greater number of visitors to the webpage including the content item 154. Hence, the content distributor 124 is able to capitalize on the value of the content arising from SEO techniques implemented for the webpage including the content item 154.

However, as the search engines discover and the users consume the published content item 154, its ranking in the organic searches can initially increase with time and after a certain time period, it may gradually stagnate/plateau/level off or it may even decrease as other fresh content becomes available on the Internet. In different aspects, the published content item 154 may continue to be available on the webpage provided by the content distributor 124 or it may be taken down and becomes unavailable to the users. Thus, the content distributor 124 fully extracts the initial SEO value of the published content item 154 prior to discarding it.

Content item 154 may relate to any one of the different types of content which are available to the users. For example, content item 154 may relate to a current news event in which rapid developments occur and therefore, it may become outdated quickly and is discarded as fresh developments occur. Content item 154 may also relate to an ‘evergreen’ type of content, such as, health advice, parenting advice, recipes, biographies or other types which have longer shelf life as they remain interesting to users who discover them anew or users who would like to reuse it. If the published content item 154 is one of the evergreen content types, discarding the content item 154 after a certain initial time period will result in only its initial SEO value being extracted. Such a process fails to extract or capitalize on the entire value of the content item 154 which may include an additional social sharing value, engagement value or monetization value. As described herein, the engagement value of the published content item 154 arises from its ability to keep a user occupied with the webpage that includes the content item 154 or it is determined by the time the user spends with the content item 154 or from its ability to drive social sharing of content item 154 from one user to another which then generates brand awareness for and traffic back to the content distributor 124. Discarding the content item 154 without extracting its social sharing value, engagement value, monetization value, or cost reduction value thereby results in loss of valuable incremental traffic driven by social shares or advertisement, commerce, or subscription-generating revenue or cost savings in delivering content with fewer editorial and production resources.

Embodiments disclosed herein provide for mitigating the loss of revenue from the failure to capitalize on the engagement value of published content. In an embodiment, the content value monitoring module 104 determines if a transaction condition is satisfied since the initial publication of the content item 154 based on the various content related data that it monitors. When the content value monitoring module 104 determines that the transaction condition is satisfied for the content item 154, it is provided to the secondary content providing module 106 which distributes the content item 152 for re-publication. In one embodiment, the content item 152 can be made available for re-publication by content distributors other than the initial content distributor 124 along with the URL associated with the content item 154 so that the other content distributors who republish the original content item 152 can avoid SEO penalties by creating a canonical tag referencing the original URL of content item 154. In accordance with this embodiment, the initial content distributor 124 continues to retain the right to the content item 154. However, when the transaction condition is satisfied for the content item 154, the publication module 100 additionally makes the content item 152 available for republication to other content distributors 126, 128. In one embodiment, the content item 152 can be made available for re-publication to all content distributors including the initial content distributor 124. In this embodiment, the initial content distributor 124 will no longer have continued publication rights to the content item 154. However, the search crawlers continue to view the content item 154 as the original publication so re-publishers can include a canonical tag which references the content item 154 when the content item 152 is republished in accordance with embodiments described further herein. The content distributor 124 will be required to remove the content item 154 from the public domain and may have to compete with other content distributors 126, 128 in order to be able to re-publish the content item 154. The publication module 100 can implement one of the foregoing methodologies for each published content item, based on various factors such as, the content item or the contractual agreements existing between the content provider associated with the publication module 100 and the content distributor 124. Again, the content item 152 may be made available for republication via a non-bidding or a bidding process.

In an embodiment, the content valuation module 108 can provide the sale price for the content item 152 based on content metadata 160 whereby it is sold at the predetermined sale price. The sale price of a content item 152 can be based on the nature of its content. For example, if the content item 152 includes content such as, keywords associated with health topics, such content is valued higher by the advertisers and accordingly sale price for such content items can be higher. For a bidding process, the content valuation module 108 can provide the starting bid based on the content metadata 160. In one embodiment, the content metadata 160 can include the volume of network traffic or users attracted by the content 154 and an average time spent by each of the users with the content item 154. By the way of illustration and not limitation, the price or starting bid for republication of the content item 152 can be based on various metrics which can include traffic driving metrics, engagement metrics or monetization metrics. For example, the traffic driving metrics can comprise Internet or mobile traffic, including social referral traffic and virality attracted by the content item 154. Examples of engagement metrics can comprise average time spent, average clickthrough rate or shares of the content item 154 from one user to another. Examples of monetary metrics that can be considered for the pricing can includes average eCPM, cost per lead, cost per acquisition, or editorial cost associated with the content item 152. In addition, various payment models may be implemented for republication of content. For example, the publication module 100 may collect the price for republishing the content item 152 via different commercial transactions, such as, in a single sale transaction or it may implement a subscription model whereby content distributors may have to pay a subscription fee at predetermine time periods in order to retain rights to republish the content item 152. In other embodiments, the publication module 100 may implement commercial transactions such as a revenue share or content for traffic arrangement. Thus, the content originator can maximize various component values of the original content item 152 in two complementary steps wherein a SEO value of the content is initially extracted and subsequently the engagement value is monetized.

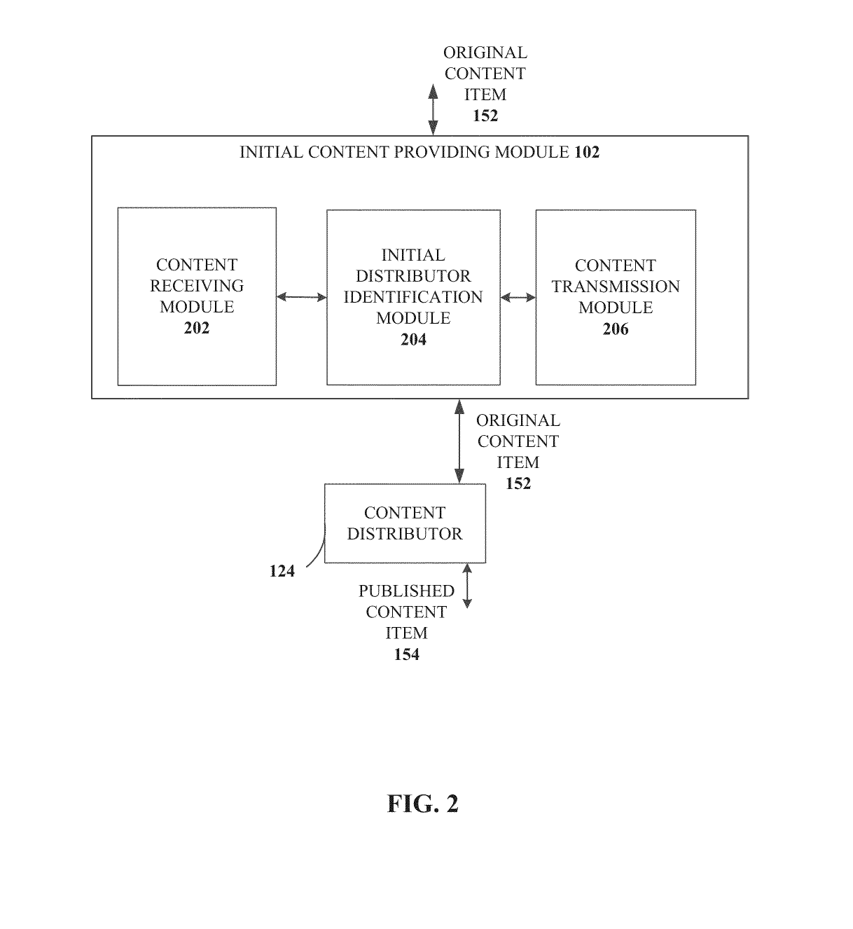

FIG. 2 is a block diagram depicting certain sub-modules within the initial content providing module 102. The initial content providing module 102 comprises a content receiving module 202, initial distributor identification module 204 and content transmission module 206. The initial content providing module 102 initially receives un-published content item 152 and makes it available for discovery by one or more of the content distributors 124, 126 and 128. In different embodiments, the content item 152 may be provided directly to content distributors 124, 126 and 128 or it may be made available for discovery by the content distributors 124, 126 and 128 via the syndication platform 122. In another embodiment, the content item 152 can be provided only to one of the content distributors, for example, the content distributor 124 for initial publication via an exclusive arrangement. Again, as described supra, the content distributor for the unpublished content item 152 may be identified via a bidding or non-bidding procedure.

The content receiving module 202 initially receives the unpublished content item 152 from the datastore 130. In an embodiment, the unpublished content item 152 can be provided to the content receiving module 202 in a push process via a notification sent to the content receiving module 202 upon receipt of the content item 152 in the datastore 130. In an embodiment, the unpublished content item 152 may be pulled by the content receiving module 202 from the datastore 130 during a procedure executed periodically for discovery of new/unpublished content items. The initial distributor identification module 204 identifies or selects one of the plurality of content distributors 124, 126 or 128 for providing the unpublished content item 152 for initial distribution in accordance with the procedures described supra. Information regarding the selected content distributor is communicated to the content transmission module 206 which provides the unpublished content item 152 to the selected content distributor, for example, content distributor 124. It may be appreciated that procedures can be implemented by the content transmission module 206 whereby the unpublished content item 152 is provided to the selected content distributor 124 only upon satisfaction of certain terms and conditions by the content distributor 124, for example, payment terms. In the event that the content distributor 124 fails to satisfy all the terms and conditions of the sale, the content transmission module 206 may require the initial distributor identification module 204 to identify one of the other content distributors 126 or 128 to provide the unpublished content item 152 for initial publication.

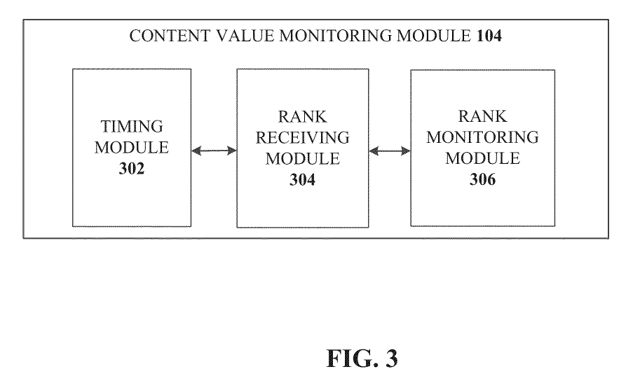

FIG. 3 is a block diagram depicting certain sub-modules within the content value monitoring module 104 which is operable to monitor value of a published content item and initiate a secondary transaction. The content value monitoring module 104 comprises a timing module 302, a rank receiving module 304 and a rank monitoring module 306. As described supra, the content distributor 124 obtains exclusive rights to the published content item 154 for a certain initial/first predetermined time period. The initial time period can be configured within the publication module 100, for example, via the timing module 302 which tracks the time elapsed since the publication of the content item 154. Upon expiry of the initial time period, the timing module 302 automatically notifies the secondary content providing module 106 to make the content item 152 available for republication to other content distributors. The initial time period can be configured based on various factors as will be detailed further herein. Again, the content distributor 124 may or may not have continued publication rights to the content item 154 upon the expiry of the initial time period. In either case, the content item 154 includes a canonical tag that identifies the content distributor 124 as the original source of the content item 154.

The content distributor 124 can optimize the online publication 154 for discovery by the search engines via various SEO methodologies generally known in the art. Accordingly, upon initial publication, the ranking of the published content item 154 in the Search Engine Results Page (SERP) initially rises at it is increasingly discovered by the search engines and gains popularity among the users. However, after passage of certain time period, for example, about two to four weeks, the ranking of the published content item 154 may stop increasing. It can either plateau at a certain value or it may start decreasing as other fresh content is published. In one embodiment, the initial time period can be configured to extend for a variable time period, such as, two to four weeks. This permits the content distributor 124 who initially published the content item 154 to extract all the SEO value accrued for the content item 154 or capitalize on the initial network traffic generated by the content item 154. Accordingly, the content value monitoring module 104 automatically alerts the secondary content providing module 106 upon expiry of the initial time period to circulate the original content item 152 for republication among the various content distributors.

In an embodiment, upon the expiry of the initial time period, the rank receiving module 304 begins to receive rank of the content item 154 in the SERP of a search engine. Various tools currently exist that can determine the rank of a content item in a SERP of one or more search engines when provided with a URL associated with the content item. The rank receiving module 302 can be configured to receive rank of the published content item 154 from such existing tools. In an embodiment, rank receiving module 302 can be configured to receive rank of the published content item 154 among the SERP of a plurality of different search engines. In an embodiment, the rank receiving module 302 can receive the rank of the published content item 154 in a pull transaction from the ranking tool (not shown). In an embodiment, the rank of the published content item 154 can be pushed to the rank receiving module 302 by the ranking tool.

The rank of the published content item 154 thus obtained is conveyed to the rank monitoring module 304. In an embodiment ranking of the content item in a SERP can be based various metrics. By the way of illustration and not limitation, the metrics can include traffic driving metrics, engagement metrics or monetization metrics. For example, the traffic driving metrics can comprise Internet or mobile traffic, including social referral traffic and virality attracted by a content item. Examples of engagement metrics can comprise average time spent, average clickthrough rate or shares of the content item from one user to another. Examples of monetary metrics that can be considered for ranking the content in a SERP of a search engine can includes average eCPM, cost per lead, cost per acquisition, or editorial cost associated with the content item initially published by the first content distributor on a website. In one embodiment, if the ranks of the published content item 154 in the SERP of a plurality of search engines are received, the rank monitoring module 304 can be configured to compute an average rank of the published content item 154 among the plurality of search engines and record the average rank within the datastore 130. In an embodiment, the rank monitoring module 304 can compute a weighted average rank based on the market share of the search engines monitored where the search engines with higher market share have more influence on the overall ranking. For example, if a first search engine has 50% market share and a second search engine has 10% market share, the former search engine has 5 times the weighting of the latter. In an embodiment, the rank monitoring module 304 compares the average rank of the published content item 154 of a given day with that of its average rank from the previous day in order to detect any changes in the rank. The changes in the rank of the content item 154 are recorded within the datastore 130 in order to identify the trends. No action is initiated by the publication module 100 when the rank of the published content item 154 is increasing. This permits the content distributor 124 who initially published content item 154 to extract the entire value associated with the initial network traffic generated by the published content item 154. When the rank monitoring module 304 detects that there is a stagnation or decrease in the rank of the published content item 154 over a configurable second time period, it can automatically notify the secondary content providing module 106 to circulate the original content item 152 for republication among the various content distributors.

In an embodiment, the publication module 100 can be configured to automatically circulate the content item 152 for republication among the various content distributors based only on the changes in the rank of the published content item 154. In this embodiment, the rank receiving module 304 begins receiving the rank of the content item 154 even as the content item 154 is initially published by the content distributor 124. The rank monitoring module 306 monitors the rank of the content item 154 to detect a stagnation or decrease in the rank of the content item 154 over the second time period. When such a stagnation or decrease is detected, the rank monitoring module 306 notifies the secondary content providing module 106 to circulate the content item 152 for republication among the various content distributors. Content distributors republish the content item 152 to increase engagement on their website based on the user's time spent with the content item 154 or shares of the content item 154 from one user to another or to reduce content production costs by using third party content sources rather than internal staff to produce content.

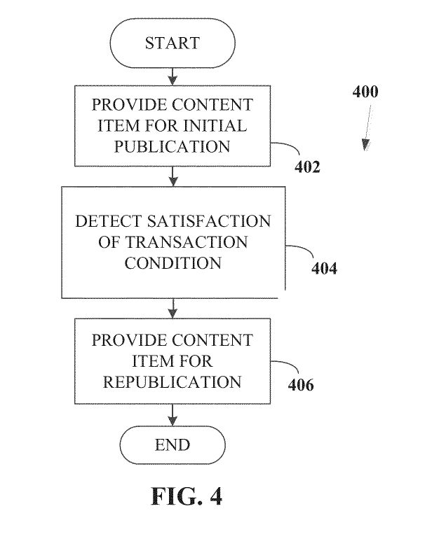

FIG. 4 shows a flowchart 400 illustrating an embodiment of a method of extracting traffic-driving SEO value of a content item along with its engagement and cost-reduction value. The method begins at step 402 wherein an original, unpublished content item is initially provided to a first content distributor for initial publication. In an embodiment, the original content item is designated as having a SEO value by a syndication platform (or a content provider) and is made visible by the syndication platform to prospective third party content distributors. In this embodiment, the third party content distributors can have electronic means to access the original, unpublished content item. For example, the feeds comprising metadata of the unpublished content item, such as, its title, author, summary or snippets of content can be forwarded to the third party content distributors or the third party content distributors can have access to a protected database of unpublished content. As described herein, the first content distributor 124 is generally an exclusive distributor for the content item 152 and will always extract the most SEO value of the content item 152 because only the first distributor will get credit for publishing content item 152. Subsequent to the initial publication, it is detected at 404 when a transaction condition is satisfied. In an embodiment, passage of a certain initial time period can satisfy the transaction condition. In an embodiment as detailed herein, the satisfaction of a transaction condition is dependent on the extraction of the SEO value of the content item by the initial content distributor. In an embodiment, the satisfaction of the transaction condition is associated with a combination of the aforementioned factors. Upon the transaction condition being satisfied in accordance with embodiments described herein, the content item 152 is provided for republication to other content distributors as shown at 406. In another embodiment, the initially published version 154 can be circulated for republication based on the arrangement between the content distributor 124 and the operator of the publication module 100.

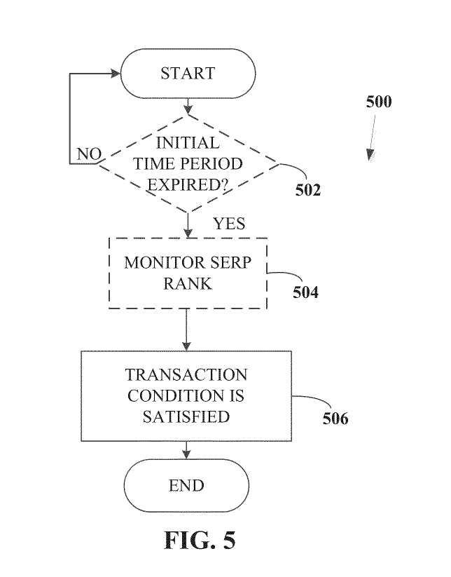

FIG. 5 shows a flowchart 500 illustrating embodiments of a methods of detecting if a transaction condition is satisfied in order to circulate an already published content item for republication. The method commences at 502 wherein it is determined if a certain initial time period has expired. In an embodiment, the expiry of the initial time period at 502 will satisfy the transaction condition at 506. Hence, in accordance with this embodiment, the procedure will jump to step 506 from step 502 without the intermediate step of monitoring the SERP rank of the published content item 154 shown at 504. This will cause the content item 152 to be automatically circulated for republication among different publishers upon the expiry of the initial time period. In an embodiment, the initial time period can be configured to expire at a variable time period which, in this example, is two to four weeks from the initial, exclusive publication of the content item 154 by the first content distributor. This will not only give the first content distributor time to extract the maximum SEO value but it will also provide the time needed for different search engines to properly index the webpage including the content item 154 in order to reproduce it in the SERP.

In an embodiment, upon expiry of the initial time period at 502, a monitoring routine for the SERP ranking of the published content item 154 is initiated as shown at 504. As discussed herein, the rank monitored at step 504 can be the rank of the published content item 154 on the SERP of a single search engine or it can be a weighted average of the ranks of the published content item 154 in the SERPs of a plurality of search engines. The rank monitoring routine initiated at step 504 will be discussed in detail further infra. The conclusion of the rank monitoring routine at step 504 will cause the transaction condition to be satisfied as shown at step 506 so that the published content item 154 can be circulated for republication among the various distributors.

In an embodiment, the rank monitoring routine is initiated at step 504 even as a content item 154 is first published by the initial content distributor without waiting for the initial time period to expire. In this embodiment the procedure 500 will not include step 502, rather it will commence at step 504 directly with the initiation of the rank monitoring routine upon the first publication of the content item 154. Subsequently, when the rank monitoring routine concludes at step 504, the transaction condition will be satisfied at 506 so that the content item 152 can be provided to various content distributors for republication.

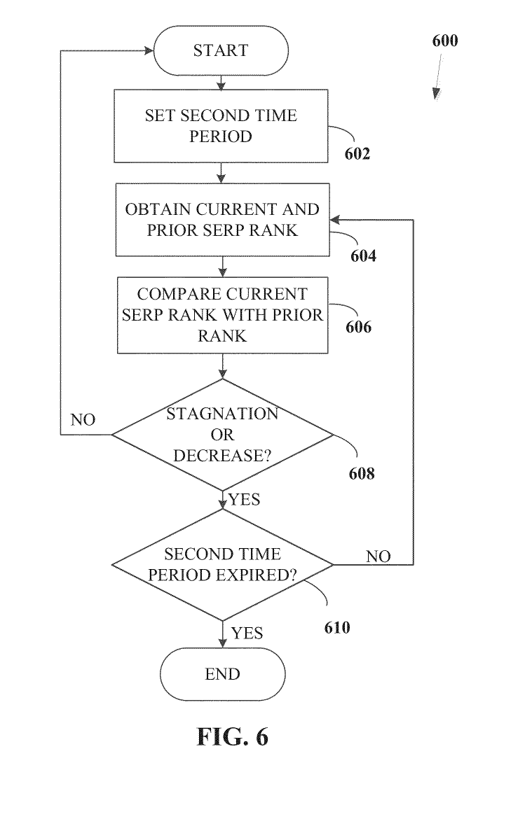

FIG. 6 shows a flowchart 600 illustrating an embodiment of a method of monitoring rank of a published content item 154. The method begins at step 602 wherein a second time period is initially set during which a decreasing or stagnation trend in the SERP rank of the published content item 154 is to be detected. For example, the second time period can expire at about two to four days after the initial detection of the decrease or the stagnation in the rank of the published content item 154. At step 604, a current and a prior SERP rank of a published content item 154 are obtained. It may be appreciated that the first time the rank monitoring routine is executed, a prior rank of the published content item 154 may not be available and that the routine needs to be executed at least once before a current and a prior SERP ranks of the published content item 154 are available within the publication module. Again as described herein the values obtained at step 604 can be the rank of the published content item 154 in the SERP of a single search engine or it can be an average value, such as, a weighted average value across the SERPs of different search engines. The current rank and the prior ranks obtained at 604 are compared as shown at step 606. At step 608, it is determined if the current rank is the same as the prior rank or if it has decreased as compared with the prior rank. If it is determined at 608 that the current rank has not stagnated or decreased, then the current rank of the published content item 154 has increased as compared with the prior rank. At this time it may be concluded that the initial content distributor 124 has not yet fully capitalized on the initial network traffic generated by the SEO of the published content item 154. The rights for publication of the content item 154 continue to vest with the initial content distributor 124 in order to let the initial content distributor extract the full SEO value of the published content item 154. Accordingly, the process returns to the beginning wherein the procedure is initiated with setting a new second time period at step 602. If, at 608, it is determined that the current rank has leveled off/stagnated or decreased, the process moves to step 610 wherein it is determined if the second time period has expired. In particular, the publication module 100 is configured to identify trends in the SERP rank changes over a predetermined second time period prior to republication. Therefore, if it is determined at 610 that the second time period has not yet expired, the process returns to step 604 to continue monitoring the SERP rank of the published content item 154. It, at 610 it is determined that the second time period has expired, the rank monitoring routine concludes on the end block. This satisfies the transaction condition and the content item 152 is circulated among the various third party content distributors for republication.

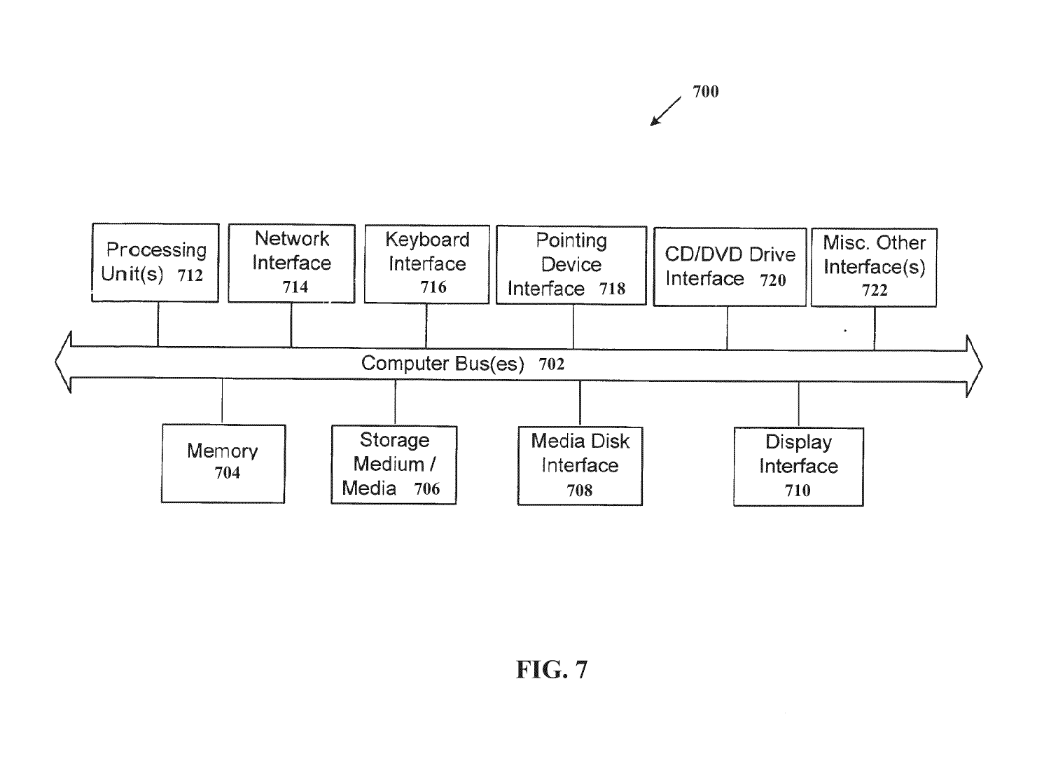

As shown in the example of FIG. 7, internal architecture of a computing device 700 includes one or more processing units (also referred to herein as CPUs) 712, which interface with at least one computer bus 702. Also interfacing with computer bus 702 are persistent storage medium/media 706, network interface 714, memory 704, e.g., random access memory (RAM), run-time transient memory, read only memory (ROM), etc., media disk drive interface 708, an interface 720 for a drive that can read and/or write to media including removable media such as floppy, CD-ROM, DVD, etc., media, display interface 710 as interface for a monitor or other display device, keyboard interface 716 as interface for a keyboard, pointing device interface 718 as an interface for a mouse or other pointing device, and miscellaneous other interfaces 722 not shown individually, such as parallel and serial port interfaces, a universal serial bus (USB) interface, and the like.

Memory 704 interfaces with computer bus 702 so as to provide information stored in memory 704 to CPU 712 during execution of software programs such as an operating system, application programs, device drivers, and software modules that comprise program code or logic, and/or computer-executable process steps, incorporating functionality described herein, e.g., one or more of process flows described herein. CPU 712 first loads computer-executable process steps or logic from storage, e.g., memory 704, storage medium/media 706, removable media drive, and/or other storage device. CPU 712 can then execute the stored process steps in order to execute the loaded computer-executable process steps. Stored data, e.g., data stored by a storage device, can be accessed by CPU 712 during the execution of computer-executable process steps.

Persistent storage medium/media 706 is a computer readable storage medium(s) that can be used to store software and data, e.g., an operating system and one or more application programs. Persistent storage medium/media 706 can also be used to store device drivers, such as one or more of a digital camera driver, monitor driver, printer driver, scanner driver, or other device drivers, web pages, content files, metadata, playlists and other files. Persistent storage medium/media 706 can further include program modules and data files used to implement one or more embodiments of the present disclosure.

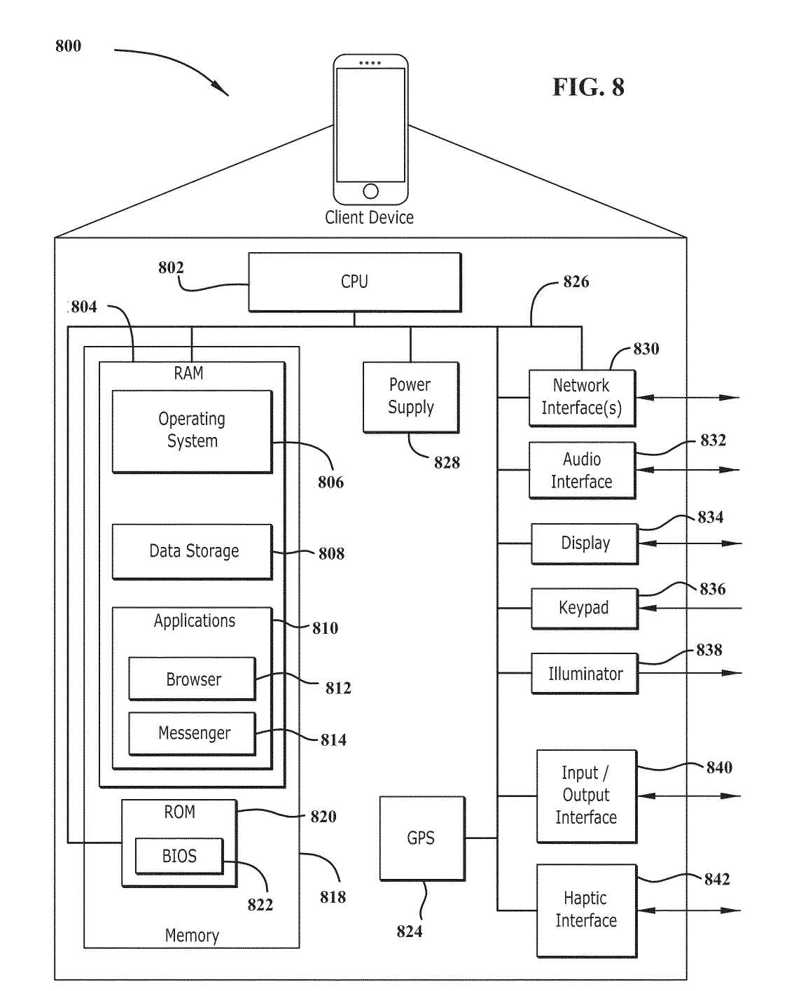

FIG. 8 is a schematic diagram illustrating a client device implementation of a computing device in accordance with embodiments of the present disclosure. A client device 800 may include a computing device capable of sending or receiving signals, such as via a wired or a wireless network, and capable of running application software or “apps”. A client device may, for example, include a desktop computer or a portable device, such as a cellular telephone, a smart phone, a display pager, a radio frequency (RF) device, an infrared (IR) device, a Personal Digital Assistant (PDA), a handheld computer, a tablet computer, a laptop computer, a set top box, a wearable computer, an integrated device combining various features, such as features of the forgoing devices, or the like.

A client device may vary in terms of capabilities or features. The client device can include standard components such as a CPU 802, power supply 828, a memory 818, ROM 820, BIOS 822, network interface(s) 830, audio interface 832, display 834, keypad 836, illuminator 838, I/O interface 840 interconnected via circuitry 826. Claimed subject matter is intended to cover a wide range of potential variations. For example, the keypad 836 of a cell phone may include a numeric keypad or a display 834 of limited functionality, such as a monochrome liquid crystal display (LCD) for displaying text. In contrast, however, as another example, a web-enabled client device 800 may include one or more physical or virtual keyboards 836, mass storage, one or more accelerometers, one or more gyroscopes, global positioning system (GPS) 824 or other location identifying type capability. Haptic interface 842, or a display with a high degree of functionality, such as a touch-sensitive color 2D or 3D display, for example. The memory 818 can include Random Access Memory 804 including an area for data storage 808.

A client device may include or may execute a variety of operating systems 806, including a personal computer operating system, such as a Windows, iOS or Linux, or a mobile operating system, such as iOS, Android, or Windows Mobile, or the like. A client device 800 may include or may execute a variety of possible applications 810, such as a client software application 814 enabling communication with other devices, such as communicating one or more messages such as via email, short message service (SMS), or multimedia message service (MMS), including via a network, such as a social network, including, for example, Facebook, LinkedIn, Twitter, Flickr, or Google+, to provide only a few possible examples. A client device 800 may also include or execute an application to communicate content, such as, for example, textual content, multimedia content, or the like. A client device 800 may also include or execute an application 812 to perform a variety of possible tasks, such as browsing, searching, playing various forms of content, including locally stored or streamed content, such as, video, or games (such as fantasy sports leagues). The foregoing is provided to illustrate that claimed subject matter is intended to include a wide range of possible features or capabilities.

For the purposes of this disclosure a computer readable medium stores computer data, which data can include computer program code that is executable by a computer, in machine readable form. By way of example, and not limitation, a computer readable medium may comprise computer readable storage media, for tangible or fixed storage of data, or communication media for transient interpretation of code-containing signals. Computer readable storage media, as used herein, refers to physical or tangible storage (as opposed to signals) and includes without limitation volatile and non-volatile, removable and non-removable media implemented in any method or technology for the tangible storage of information such as computer-readable instructions, data structures, program modules or other data. Computer readable storage media includes, but is not limited to, RAM, ROM, EPROM, EEPROM, flash memory or other solid state memory technology, CD-ROM, DVD, or other optical storage, magnetic cassettes, magnetic tape, magnetic disk storage or other magnetic storage devices, or any other physical or material medium which can be used to tangibly store the desired information or data or instructions and which can be accessed by a computer or processor.

For the purposes of this disclosure a system or module is a software, hardware, or firmware (or combinations thereof), process or functionality, or component thereof, that performs or facilitates the processes, features, and/or functions described herein (with or without human interaction or augmentation). A module can include sub-modules. Software components of a module may be stored on a computer readable medium. Modules may be integral to one or more servers, or be loaded and executed by one or more servers. One or more modules may be grouped into an engine or an application.

Those skilled in the art will recognize that the methods and systems of the present disclosure may be implemented in many manners and as such are not to be limited by the foregoing exemplary embodiments and examples. In other words, functional elements being performed by single or multiple components, in various combinations of hardware and software or firmware, and individual functions, may be distributed among software applications at either the client or server or both. In this regard, any number of the features of the different embodiments described herein may be combined into single or multiple embodiments, and alternate embodiments having fewer than, or more than, all of the features described herein are possible. Functionality may also be, in whole or in part, distributed among multiple components, in manners now known or to become known. Thus, myriad software/hardware/firmware combinations are possible in achieving the functions, features, interfaces and preferences described herein. Moreover, the scope of the present disclosure covers conventionally known manners for carrying out the described features and functions and interfaces, as well as those variations and modifications that may be made to the hardware or software or firmware components described herein as would be understood by those skilled in the art now and hereafter.

While the system and method have been described in terms of one or more embodiments, it is to be understood that the disclosure need not be limited to the disclosed embodiments. It is intended to cover various modifications and similar arrangements included within the spirit and scope of the claims, the scope of which should be accorded the broadest interpretation so as to encompass all such modifications and similar structures. The present disclosure includes any and all embodiments of the following claims.

What is claimed is:

1. A method of providing content, comprising:
providing, by a processor, a content item for initial publication to a first content distributor;
determining, by the processor, satisfaction of a transaction condition for the content item initially published by the first content distributor;
providing, by the processor, the content item for re-publication to at least one other content distributor different from the first content distributor upon the satisfaction of the transaction condition.

2. The method of claim 1, further comprising
detecting, by the processor, expiry of a predetermined first time period.

3. The method of claim 2, wherein the transaction condition is satisfied upon the expiry of the predetermined first time period.

4. The method of claim 2, wherein determining, by the processor, the satisfaction of the transaction condition further comprises:
obtaining, by the processor, a SERP (Search Engine Results Page) ranking of the content item initially published by the first content distributor upon the expiry of the predetermined first time period;
monitoring, by the processor, the ranking of the content item initially published by the first content distributor;
detecting, by the processor, stagnation of the ranking or decrease in the ranking for a predetermined second time period.

5. The method of claim 1, wherein determining, by the processor, the satisfaction of the transaction condition further comprises:
obtaining, by the processor, a ranking of the content item initially published by the first content distributor;
monitoring, by the processor, the ranking of the content item initially published by the first content distributor; and
detecting, by the processor, stagnation of the ranking or decrease in the ranking for a predetermined second time period.

6. The method of claim 1, wherein the at least one other content distributor comprises a plurality of content distributors and the content item is provided for re-publication to the plurality of other content distributors, by the processor, at a predetermined price.

7. The method of claim 6, wherein the predetermined price for the re-distribution of the content item is based on content type comprised within the content item.

8. The method of claim 1, wherein providing the content item for re-publication further comprising:
providing, by the processor, the content item for auction; and
determining, by the processor, a price for re-distribution of the content item based on results of the auction;
selecting, by the processor, the at least one other content distributor based on results of the auction.

9. The method of claim 1, further comprising
determining, by the processor, a price for the re-distribution of the content item based on a SERP ranking of the content item initially published by the first content distributor.

10. The method of claim 9 wherein the ranking of the content item is based on Internet traffic attracted by the content item initially published by the first content distributor on a website.

11. The method of claim 9 wherein the ranking of the content item is based on a monetization metric associated with the content item initially published by the first content distributor on a website.

12. The method of claim 9 wherein the ranking of the content item is based on a engagement metric associated with the content item initially published by the first content distributor on a website.

13. The method of claim 1, further comprising
collecting, by the processor, a price for the re-distribution of the content item from the at least one other content distributor via a subscription.

14. A computing device comprising:
a processor,
a storage medium for tangibly storing thereon program logic for execution by the processor, the program logic comprising:
providing logic, executed by the processor, for providing a content item for initial publication to a first content distributor;
determining logic, executed by the processor, for determining satisfaction of a transaction condition for the content item by the first content distributor;
republication logic, executed by the processor, for providing the content item for re-publication to at least one other content distributor different from the first content distributor upon the satisfaction of the transaction condition.

15. The device of claim 14, further comprising:
detecting logic, executed by the processor, for detecting, expiry of a predetermined first time period.

16. The device of claim 15, wherein the determining logic further comprises:
transaction logic, executed by the processor, for determining if the transaction condition is satisfied upon the expiry of the predetermined first time period.

17. The device of claim 15, wherein the determining logic further comprises:
obtaining logic, executed by the processor, for obtaining a SERP (Search Engine Results Page) ranking of the content item initially published by the first content distributor upon the expiry of the predetermined time period;
monitoring logic, executed by the processor, for monitoring the ranking of the content item initially published by the first content distributor;
identifying logic, executed by the processor, for identifying stagnation of the ranking or decrease in the ranking for a predetermined second time period.

18. The device of claim 14, wherein the determining logic further comprises:
obtaining logic, executed by the processor, for obtaining a SERP (Search Engine Results Page) ranking of the content item initially published by the first content distributor;
monitoring logic, executed by the processor, for monitoring the ranking of the content item initially published by the first content distributor;
identifying logic, executed by the processor, for identifying stagnation of the ranking or decrease in the ranking for a predetermined second time period.

19. The device of claim 14, wherein the at least one other content distributor comprises a plurality of content distributors and the republication logic executed by the processor further comprises:
logic, executed by the processor, for providing the content item for re-publication to the plurality of other content distributors, by the processor, at a predetermined price.

20. The device of claim 14, the re-publication logic further comprises:
auctioning logic, executed by the processor, for auctioning the content item;
pricing logic, executed by the processor, for determining a price for re-distribution of the content item based on results of the auction;
selecting logic, executed by the processor, for selecting the at least one other content distributor based on results of the auction.

21. The device of claim 14, further comprising:
price determining logic, executed by the processor, for determining a price for the content item based on Internet traffic comprising social referral traffic and virality attracted by the content item when initially published by the first content distributor on a website.

22. The device of claim 14, further comprising:
collecting logic, by the processor, for collecting a price for the re-distribution of the content item from at least one other content distributor via a commercial transaction.

23. A computer readable storage medium, comprising instructions, which when executed by a processor cause the processor to:
provide a content item for initial publication to a first content distributor;
determine satisfaction of a transaction condition for the content item by the first content distributor;
provide the initially published content item for re-publication to at least one other content distributor different from the first content distributor upon the satisfaction of the transaction condition.

24. The computer readable medium of claim 23, further comprising instructions which when executed by a processor, cause the processor to:
detect expiry of a predetermined first time period.

25. The computer readable medium of claim 24, further comprising instructions which when executed by a processor, cause the processor to:
obtain a SERP (Search Engine Results Page) ranking of the content item initially published by the first content distributor upon the expiry of the predetermined time period;
monitor the ranking of the content item initially published by the first content distributor;
detect stagnation of the ranking or decrease in the ranking for a predetermined second time period.

26. The computer readable medium of claim 23, wherein instructions for determining the satisfaction of the transaction condition further comprise instructions that cause the processor to:
obtain a ranking of the content item initially published by the first content distributor;
monitor the ranking of the content item initially published by the first content distributor; and
detect stagnation of the ranking or decrease in the ranking for a predetermined second time period.

27. The computer readable medium of claim 23, further comprising instructions that cause the processor to:
collect a price for the re-distribution of the content item from at least one other content distributor via a commercial transaction.
